(19) United States
(12) Patent Application Publication
(10) Pub. No.: US 2018/0137245 A1
(43) Pub. Date: May 17, 2018

(54) AUTOMATED TRANSFER OF PATIENT DATA TO A MEDICAL IMAGING APPARATUS

(71) Applicant: Siemens Healthcare GmbH, Erlangen (DE)

(72) Inventor: Thomas Benner, Erlangen (DE)

(73) Assignee: Siemens Healthcare GmbH, Erlangen (DE)

(21) Appl. No.: 15/813,619

(22) Filed: Nov. 15, 2017

(30) Foreign Application Priority Data
Nov. 15, 2016 (DE) 102016222377.1

(51) Int. Cl. G06F 19/00; H04L 29/06

(52) U.S. Cl. CPC G06F 19/321; G06F 19/3418; H04L 63/08

(57) ABSTRACT

In a method and components for automated transfer of patient data to a medical imaging apparatus, a communication connection between a patient and a communication module of the medical imaging apparatus is established automatically. It is then identified whether the patient has granted release of patient data, and if the patient has granted release, the patient data are transferred from a patient-data storage source to the medical imaging apparatus.

### BACKGROUND OF THE INVENTION

### Field of the Invention

The invention concerns a method for automated transfer of patient data to a medical imaging apparatus, as well as a communication module, a data transfer system, and a medical imaging apparatus that participate in implementing such a method.

### Description of the Prior Art

Two-dimensional or three-dimensional image data that can be used for visualizing an imaged subject under examination as well as for other applications are commonly produced by modern imaging techniques.

Before starting a medical imaging apparatus, for instance a magnetic resonance imaging system, personal information about the patient is needed, for example the patient's name, age, gender, weight, size, medication used and contraindications. This information is conventionally obtained from the patient manually, i.e. for instance by entering the information in a form displayed on a screen. Alternatively, the data may already exist in a hospital information system so as to be obtainable directly from a central data storage device of the hospital information system.

The described modes of information transfer has a number of disadvantages. Completing the forms is labor-intensive and time-consuming, and clerical errors can easily occur in the process. The manual checking of contraindications takes time and is prone to errors. If the patient data are entered and checked manually, directly at the medical imaging apparatus, then precious operating time for the medical imaging apparatus is lost. In addition, data from a hospital information system may be out of date and contain errors. Customarily in this case, data must be updated by hand, which again can be very time-consuming and laborious.

### SUMMARY OF THE INVENTION

An object of the invention is to design the transfer of patient data to a medical imaging apparatus to be more efficient, faster, more accurate, and more reliable.

In the method according to the invention for automated transfer of patient data to a medical imaging apparatus, a communications connection is established between a patient and a communication module of the medical imaging apparatus. This can mean, for example, that the patient operates a keyboard of the communication module and thereby communicates with the medical imaging apparatus. As explained below, the communication connection can also be established in an automated manner between the communication module and a mobile terminal known to be associated with the patient or the like. In this case, the patient uses his or her mobile terminal to communicate with the communication module of the medical apparatus.

It is subsequently identified whether the patient has granted release of patient data. This determination can be made, for example, as part of a release dialog between the patient and the medical imaging apparatus. During the release dialog, it is identified whether the patient releases his or her patient data for transfer to the medical imaging apparatus, and, if applicable, how much of this data is meant to be released. If the patient has granted release, finally the released patient data are transferred from a patient-data storage device to the medical imaging apparatus. The release can be made by the patient by pressing a button, for example, i.e. the patient operates a keyboard at the communication module. As explained below, the release can also be made using technical equipment associated with the patient, for instance equipment such as a mobile terminal.

In the method according to the invention, instead of patient data having to be captured manually, such data are advantageously provided to an image acquisition preparation computer without any additional effort on the part of operating personnel of the medical imaging apparatus. Since the patient must grant release in order to cause the transfer of his or her patient data, the patient still retains full control over his or her patient data, allowing compliance with data protection regulations. In addition, the automatic transfer of the patient data avoids mistakes that can arise with manual entry of such data as a result of typing errors, misinterpretations, or mistakes that cause the information to be incorrect.

The communication module according to the invention for a medical imaging apparatus has a connection setup interface that establishes a communication connection between a patient and the communication module of the medical imaging apparatus. In the simplest case, the connection setup interface can be a keyboard of the communication module, via which the patient can communicate with the medical imaging apparatus. If the patient is using a mobile terminal or the like for communication, then the connection setup interface may be a transceiver for automatic initiation of communication with the mobile terminal of the patient as soon as the patient approaches the medical apparatus.

In addition, the communication module according to the invention has a release checker that determines whether the patient has granted release of the patient data. The communication module according to the invention also has a patient data retrieval interface that retrieves the released patient data from a patient-data storage source if the patient has granted release.

The data transfer system according to the invention includes the patient-data storage source and the communication module. In addition, the data transfer system according to the invention can also include a mobile data processor, which the patient can use to conduct the release dialog with the medical imaging apparatus.

The medical imaging apparatus according to the invention has a scanner for acquiring raw data from a region under examination of the patient, an image reconstruction computer that reconstructs image data on the basis of the acquired raw data, and the communication module according to the invention.

Some of the basic components of the communication module according to the invention and the data transfer system according to the invention can be embodied in the form of software components. This applies in particular to the connection setup interface, the release checker and the patient retrieval interface. In principle, some of these components can also be implemented in the form of software-supported hardware, for instance FPGAs or the like, particularly when especially fast calculations are needed. Likewise, the required interfaces can be designed as software interfaces, for instance if all that is involved is a transfer of data from other software components. They can also be designed as hardware interfaces driven by suitable software.

An implementation largely in software has the advantage that communication modules already in use in medical imaging apparatuses can be easily upgraded by a software update in order to operate according to the invention. The invention thus also encompasses a non-transitory, computer-readable data storage medium encoded with program code. The storage medium can be loaded directly into a memory of a medical imaging apparatus and the program code cause the computer of the apparatus to perform all the steps of the method according to the invention. The storage medium may include, in addition to the aforementioned program code, then elements such as documentation and/or components, including hardware components, such as hardware keys (dongles, etc.) for using the software.

The computer-readable storage medium can be a memory stick, a hard disk or any other portable or permanently installed data storage medium on which the program code is stored.

In an embodiment of the method according to the invention, a communication connection is established between a mobile data processing device belonging to the patient and a communication module of the medical imaging apparatus in an automated manner. In other words, if the patient, together with his or her mobile data processing device, comes within a specified communication range of the communication module of the medical imaging apparatus, this proximity is detected and a connection is established between the communication module of the medical imaging apparatus and the mobile data processing device of the patient. It is subsequently identified whether release of patient data has been granted using the data processing device belonging to the patient.

A smartphone, a smartwatch, a portable computer, a smartcard, a portable medical monitoring device or a similar portable device known as a “smart device” can be used, for example, as the mobile data processing device of the patient. A transmission channel that can be hardwired or wireless can be used, for example, for the data transfer between the medical imaging apparatus and the mobile data processing device of the patient. The data transfer can take place, for example, via a local area network, for instance WiFi, by near field communication, or by infrared waves.

The release can be made, for example, as part of a release dialog between the medical imaging apparatus and the mobile data processing device belonging to the patient. During the release dialog, it is determined whether the patient releases his or her patient data for transfer to the medical imaging apparatus, and, if applicable, how much of this data is meant to be released. If the patient has granted release, finally the released patient data are transferred from a patient-data storage source to the medical imaging apparatus.

The release can also be made implicitly, for instance by handing over a smartcard serving as the mobile data processing device. In this case, for instance, the smartcard can be inserted into a suitable port that is part of the communication module of the medical imaging apparatus.

The patient data need not necessarily be transferred directly between the mobile data processing device and the medical apparatus, but can be transferred by a different route, for instance via the hospital information system or a separate PC or the “Cloud”.

In an embodiment of the method according to the invention, the mobile data processing device belonging to the patient is a patient-data storage device. In other words, in this variant, the patient-data storage source is part of the mobile data processing device. In this variant, the patient thus can always carry the latest patient data with him or her, and provide it to the medical imaging apparatus as required before an image acquisition.

Alternatively, the patient data can be transferred to the medical imaging apparatus from a database present in the network, i.e. a data network, for instance an intra-hospital or inter-hospital data communication network. In this variant, instead of the patient having to carry his or her own patient data with him, the data are stored in a database. If the patient releases the data prior to image acquisition by a medical imaging apparatus, then the patient data can be transmitted directly from the database to the medical imaging apparatus. Hence the patient does not personally need to reserve memory capacity for storing his or her patient data but still retains control over his or her patient data.

In another embodiment of the method according to the invention, authentication and/or identification of the patient is performed before the patient data are transferred. For this purpose, the patient can transfer a patient number or a patient code or something similar to the medical imaging apparatus in order to log in and possibly display an access permission. This can prevent misuse of data or unwanted use of a medical apparatus or a database connected to this apparatus.

In another embodiment of the method according to the invention, authentication and/or identification of the mobile data processing device belonging to the patient is performed before the patient data are transferred. This can reduce the risk of unintentionally transferring incorrect patient data or incorrectly associated patient data.

In another embodiment of the method according to the invention, in the event of release, then release is optionally granted for all of the patient data stored on the patient-data storage device, or only for some of the patient data stored on the patient-data storage device. The patient can thereby specify what data are shared with the medical imaging apparatus and what data the patient prefers to keep to himself or herself.

In another embodiment of the method according to the invention, image data acquired using the medical imaging apparatus are transferred to the patient-data storage device in an automated manner. If the patient-data storage source is part of the patient's mobile data processing device, then the patient can have access to the newly produced image data and can, for example, take this data to a doctor's appointment and provide it to the relevant doctor providing treatment. If the patient-data storage device is part of a database, then the new image data are added to this database and updates this database, and can likewise be made accessible to other medical practitioners if required.

The patient data can be at least one of the following types of data, for example:
general patient data;
contraindications;
medical information that suggests the need for special monitoring of the patient during an imaging procedure.

The method according to the invention can be used to provide this patient data to the medical imaging apparatus in an automated manner and be used to customize the imaging procedure to suit the patient.

For example, if contraindications have been identified for the patient, one of the following measures is performed in an automated manner:
adjusting apparatus limits;
blocking the use of the medical apparatus;
displaying warnings, e.g. if additional patient monitoring is required;
blocking the administration of contrast agent if there is a contraindication with ingested medications;
automated referral of the patient to a different, suitable medical imaging apparatus.

The imaging is thus adjusted with regard to protecting the health of the patient, thereby ensuring the safety of the patient.

In a further embodiment, the communication module according to the invention for a medical imaging apparatus has a connection setup interface for automatically establishing a communication connection between a mobile data processing device belonging to a patient and the communication module of the medical imaging apparatus. In addition, the communication module according to the invention has a release checker that determines whether release of patient data has been granted using the mobile data processing device belonging to the patient. The communication module according to the invention also has a patient retrieval interface for retrieving the released patient data from a patient-data storage source if the patient has granted release.

The connection between the mobile data processing device of the patient and the communication module of the medical imaging apparatus is preferably set up in an automated manner so that the patient does not need to be actively involved in initiating communication with the medical imaging apparatus. Moreover, in this embodiment, the patient can use the familiar user interface of his or her data processing device, and does not need to adjust to an unfamiliar input interface.

### BRIEF DESCRIPTION OF THE DRAWINGS

FIG. 1 is a flowchart illustrating the method for automated transfer of patient data to a medical imaging apparatus, according to a first exemplary embodiment of the invention.

FIG. 2 is a flowchart illustrating a method for automated transfer of patient data to a medical imaging apparatus, according to a second exemplary embodiment of the invention.

FIG. 3 schematically illustrates an arrangement of a medical imaging apparatus and a smartphone according to an exemplary embodiment of the invention.

### DESCRIPTION OF THE PREFERRED EMBODIMENTS

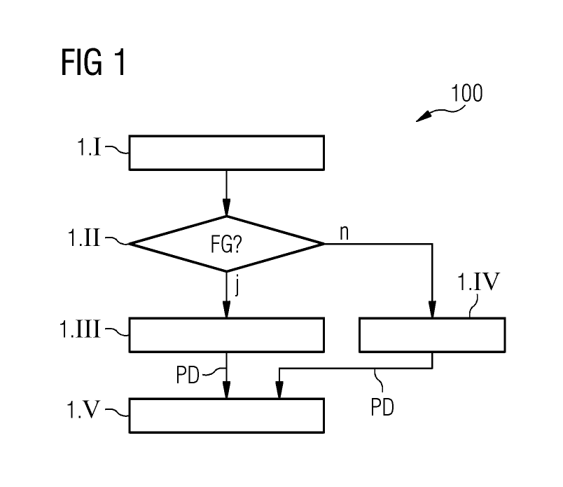

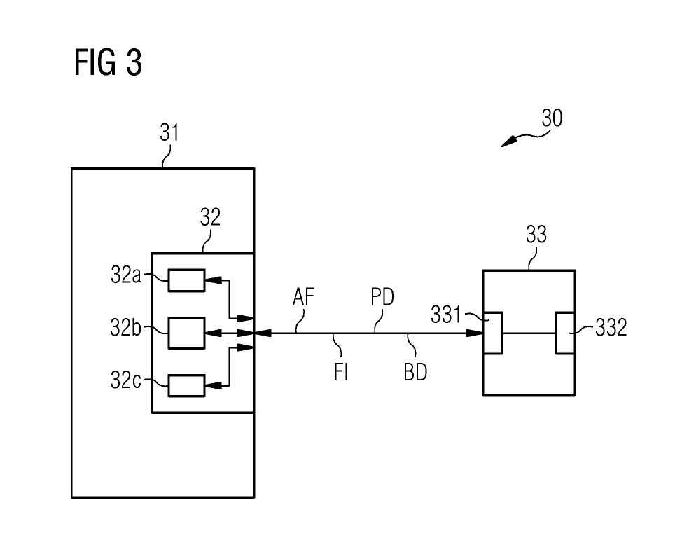

FIG. 1 shows a flowchart 100 that illustrates the method for automated transfer of patient data PD to a medical imaging apparatus, in an exemplary embodiment using a magnetic resonance imaging apparatus 31 (see FIG. 3). The patient data PD is needed in order to customize an imaging process performed using the magnetic resonance imaging apparatus 31 to suit the patient.

FIG. 3 shows an example of an arrangement 30 that can be used in the method, which arrangement includes a magnetic resonance imaging apparatus 31 and a smartphone 33.

In step 1.I, a communication connection between a smartphone 33 (see FIG. 3) of a patient to be examined and a communication module 32 of the magnetic resonance imaging system 31 (see FIG. 3) is first established. In this specific exemplary embodiment, the communication connection is a wireless communication connection such as a WLAN connection or what is known as an NFC connection (NFC=near field communication).

In step 1.II, a release dialog is conducted between the patient, in this exemplary embodiment between smartphone 33 and the communication module 32 of the magnetic resonance imaging apparatus 31. In other words, a request for release FG of patient data PD is made by the communication module 32 to the patient. If the patient is willing in principle to release at least some of his or her patient data PD, this willingness being identified by “y” in FIG. 1, the patient transfers information that includes release FG and how much and what type of patient data PD the patient is willing to release, and the method moves on to step 1.III. Then in step 1.III, the patient data PD are transferred from a patient-data storage source. The patient-data storage source can be, for example, a data storage memory 332 of the smartphone 33 of the patient, as illustrated in FIG. 3. The patient-data storage source can also be a central clinical database, to which the communication module 32 of the magnetic resonance imaging system 31 or the smartphone 33 has access. If the patient has not granted release FG for transfer of his or her patient data PD, which is identified by “n” in FIG. 1, in step 1.IV, the patient data PD are obtained manually by completion of a suitable patient data form. Finally, in step 1.V, on the basis of the acquired patient data PD, an image is acquired using the magnetic resonance imaging apparatus 31, with the acquisition taking into account the patient data PD. The patient data PD are used, for example, for specifying the limits of the SAR exposure for the patient. Any contraindications that emerge from the patient data PD can also result in using a different type of imaging system for acquiring an image of the patient.

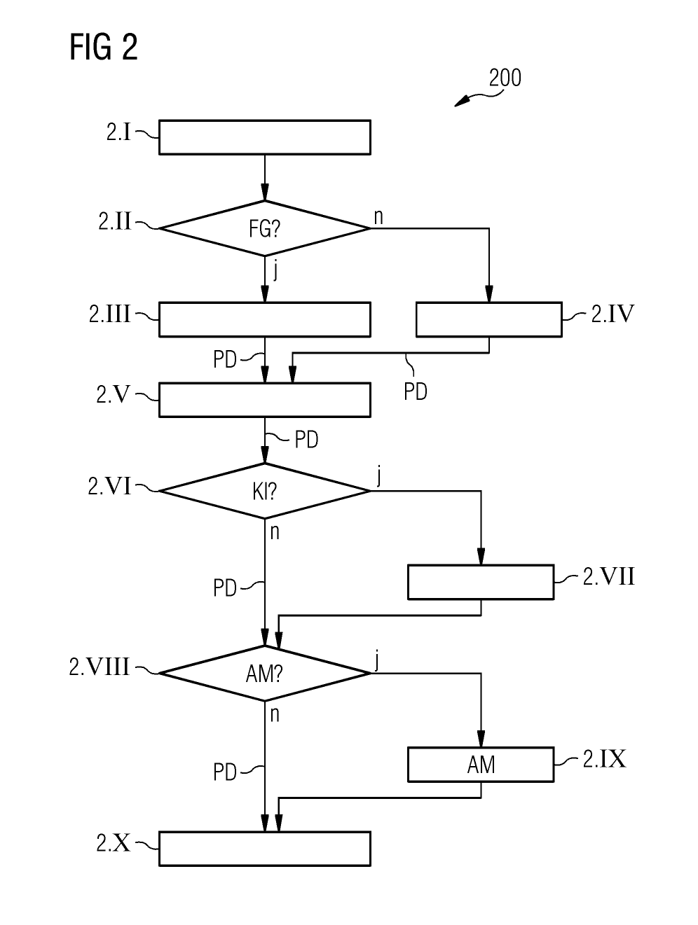

FIG. 2 shows a flowchart 200 illustrating the method for automated transfer of patient data PD to a medical imaging apparatus according to a second exemplary embodiment of the invention. The steps 2.I to 2.IV correspond to the steps 1.I to 1.IV and therefore need not be described again in detail.

Then in step 2.V, the received patient data PD are compared with older patient data from a central database, and the patient data from the central database are updated if necessary. Then in step 2.VI, it is ascertained on the basis of the patient data PD whether there are contraindications against using the magnetic resonance imaging system 31 on the patient. If contraindications KI exist, which is identified by “y” in FIG. 2, then the method moves on to step 2.VII. In step 2.VII, measures are taken to address the contraindications KI. For instance, it may be the case that it emerges from the acquired patient data PD that the patient is wearing a pacemaker. In this case it is not possible to use a magnetic resonance imaging apparatus. The diagnostics plan for the patient is then modified in step 2.VII in this case. For example, the patient is referred to a medical imaging apparatus based on a different technology such as computed tomography, for instance. Then the method moves to step 2.VIII. In the event that no contraindications KI were ascertained in step 2.VI, which is identified by “n” in FIG. 2, the method moves directly to step 2.VIII.

In step 2.VIII, the patient data PD are used as the basis for verifying whether additional monitoring must be carried out for the patient during image acquisition using the magnetic resonance imaging system or, if applicable, a different selected imaging system. If it was ascertained from the patient data PD that such monitoring is needed, which is identified by “y” in FIG. 2, then the method moves to step 2.IX, in which preparations are made for additional monitoring AM of the patient during the image acquisition. Then the method moves on to step 2.X, in which an image of the patient is acquired. If it was ascertained in step 2.VIII that no additional monitoring AM of the patient is needed, which is identified by “n” in FIG. 2, then the method moves on directly to step 2.X, in which an image of the patient is acquired, in this case without monitoring.

FIG. 3 shows an arrangement 30 that includes a medical imaging apparatus 31, in this exemplary embodiment a magnetic resonance imaging apparatus, and a smartphone 33 according to an exemplary embodiment of the invention. The medical imaging apparatus 31 has a communication modules 32. The smartphone 33 likewise has a communication module 331 and a data storage memory 332. The communication module 32 of the medical imaging apparatus 31 has a communication setup interface 32a that establishes a communication connection automatically between the medical imaging apparatus 31 and the smartphone 33. The communication module 32 of the medical imaging apparatus 31 also has a release checker 32b, designed as a release dialog processor, for conducting a release dialog with the mobile data processing device 33 belonging to the patient. In addition, the communication module 32 of the medical imaging apparatus 31 has a patient retrieval interface 32c for retrieving patient data from a patient-data storage memory 332 if the patient has granted release.

The information specified below is transferred between the communication module 32 of the medical imaging apparatus 31 and the communication module 331 of the smartphone 33. Once a communication connection has been established between the medical imaging apparatus 31 and the smartphone using connection setup unit 32a, first a release request AF is made to the smartphone 33 of the patient by the release dialog processor 32b. The patient subsequently uses his or her smartphone 33 to transfer release information FI to the communication module 32 of the medical imaging apparatus 31, or more precisely to the release dialog processor 32b. On the basis of the release information FI, the patient retrieval interface 32c of the communication module 32 now requests patient data PD from the smartphone 33 of the patient. As a result, the required patient data PD are read from the data storage memory 332 of the smartphone 33 and transmitted via the communication module 331 of the smartphone 33 to the communication module 32 of the magnetic resonance imaging apparatus 31, or more precisely to the patient retrieval interface 32c of the communication module 32. Once an image of the patient has been acquired, which acquisition has taken into account the transmitted patient data PD, image data BD from the image acquisition are transferred from the magnetic resonance imaging apparatus 31 to the smartphone 33 belonging to the patient, and stored there in the data storage memory 332.

Although modifications and changes may be suggested by those skilled in the art, it is the intention of the Applicant to embody within the patent warranted hereon all changes and modifications as reasonably and properly come within the scope of the Applicant's contribution to the art.

1. A method for automated transfer of patient data to a medical imaging apparatus, comprising:
automatically establishing a communication connection between an electronic device possessed by a patient, and a communication module of a medical imaging apparatus;
via said communication connection, establishing whether the patient has granted release of patient data concerning the patient; and
only if the patient has granted release of the patient data, transferring the release patient data from a patient data storage device to the medical imaging apparatus.

2. A method as claimed in claim 1 comprising establishing whether the patient has granted release by implementing a release dialogue between the electronic device of the patient and the communication module of the medical imaging apparatus.

3. A method as claimed in claim 1 comprising using a mobile data processing device as the electronic device possessed by the patient.

4. A method as claimed in claim 3 wherein said mobile data processing device comprises said patient data storage device.

5. A method as claimed in claim 1 comprising establishing a network communication between said communication module of the medical imaging apparatus and said patient data storage device and, if the patient has granted release of the patient data, transferring the patient data from the patient data storage device to the communication module via the network.

6. A method as claimed in claim 1 comprising establishing whether the patient has granted release of the patient data by a procedure that includes at least one of authentication or identification of the patient, before transferring the patient data from the patient data storage device to the communication module of the medical imaging apparatus.

7. A method as claimed in claim 6 comprising authenticating or identifying the patient by identifying the electronic device possessed by the patient.

8. A method as claimed in claim 1 comprising allowing the patient to grant a scope of release of the patient data that encompasses all or only some of the patient data stored in the patient data storage device, and transferring an amount of patient data from the patient storage device to the communication module of the medical imaging apparatus that is commensurate with the scope of release granted by the patient.

9. A method as claimed in claim 1 comprising transferring the patient data from the patient storage device automatically upon recognition by the communication module of the electronic device possessed by the patient.

10. A method as claimed in claim 1 comprising storing, as said patient data in said storage device, data selected from the group consisting of general patient data, contraindications with regard to treatment of the patient, and medical information concerning the patient describing a need for special monitoring of the patient during an imaging procedure.

11. A method as claimed in claim 1 comprising storing, as said patient data in said storage device, data that describe contraindications with regard to treatment of the patient and comprising, upon transfer of said patient data to said communication module of said medical imaging apparatus, implementing at least one contraindication-related measure at said medical imaging apparatus selected from the group consisting of adjusting apparatus operational limits, blocking use of the medical imaging apparatus, displaying a warning at a display screen at said medical imaging apparatus, blocking administration of contrast agent, and automated referral of the patient to a different medical imaging apparatus.

12. A communication module for a medical imaging apparatus, comprising:
a computer;
a connection setup processor in said computer configured to automatically establish a communication connection between an electronic device possessed by a patient and said connection setup processor;
a release identification processor in said computer configured to identify, via a communication with the electronic device of the patient via the communication connection, whether the patient has granted release of patient data concerning the patient; and
a patient data retrieval processor in said computer configured to access a patient storage device in order to retrieve patient data released by the patient.

13. A data transfer system comprising:
a patient data storage device in which data concerning a patient are stored;
a computer;
a connection setup processor in said computer configured to automatically establish a communication connection between an electronic device possessed by said patient and said connection setup processor;
a release identification processor in said computer configured to identify, via a communication with the electronic device of the patient via the communication connection, whether the patient has granted release of patient data concerning the patient; and
a patient data retrieval processor in said computer configured to access a patient storage device in order to retrieve patient data released by the patient.

14. A medical imaging apparatus comprising:
a medical image data acquisition scanner;
a control computer configured to operate the medical image data acquisition scanner in order to acquire raw data from a patient;
an image reconstruction computer configured to reconstruct image data from the acquired raw data;
a communication computer;
a connection setup processor in said communication computer configured to automatically establish a communication connection between an electronic device possessed by said patient and said connection setup processor;
a release identification processor in said communication computer configured to identify, via a communication with the electronic device of the patient via the communication connection, whether the patient has granted release of patient data concerning the patient; and
a patient data retrieval processor in said communication computer configured to access a patient storage device in order to retrieve patient data released by the patient.

15. A non-transitory, computer-readable data storage medium encoded with programming instructions that are distributively loaded into an electronic device possessed by a patient and a communication module of a medical imaging apparatus, said programming instructions causing said electronic device and said communication module to:
automatically establish a communication between the electronic device possessed by the patient and the communication module;
identify whether the patient has granted release of patient data concerning the patient; and
if the patient has granted release of the patient data, transfer the release patient data from a patient storage device, in which the patient data are stored, to the communication module.
